(19) United States
(12) Patent Application Publication
(10) Pub. No.: US 2025/0078208 A1
(43) Pub. Date: Mar. 6, 2025

(54) IMAGE PROCESSING SYSTEM, MOVABLE APPARATUS, IMAGE PROCESSING METHOD, AND STORAGE MEDIUM

(71) Applicant: CANON KABUSHIKI KAISHA, Tokyo (JP)

(72) Inventor: Masato ARAI, Tokyo (JP)

(21) Appl. No.: 18/805,893

(22) Filed: Aug. 15, 2024

(30) Foreign Application Priority Data
Sep. 6, 2023 (JP) 2023-144827

(51) Int. Cl. G06T 5/50

(52) U.S. Cl. CPC G06T 5/50; G06T 2207/20132; G06T 2207/20221

(57) ABSTRACT

An image processing system includes a first imaging unit including a first optical system in which a maximum half angle of view is θa, a second imaging unit including a second optical system in which a maximum half angle of view is θb, the first imaging unit and the second imaging unit being configured such that θa+θb>180° is satisfied, and an optical axis of the first optical system and an optical axis of the second optical system being disposed in opposite directions to each other, an image composition unit configured to generate composite image information of a celestial sphere based on outputs of the first imaging unit and the second imaging unit, and a distance measurement processing unit configured to generate distance information based on an output of a superimposed viewing angle of the first imaging unit and the second imaging unit.

### BACKGROUND OF THE INVENTION

### Field of the Invention

The present invention relates to an image processing system, a movable apparatus, an image processing method, a storage medium, and the like.

### Description of the Related Art

In the related art, a movable apparatus that autonomously moves at various places such as a home, an office building, a house, and a distribution center and performs work is known. Such a movable apparatus is able to perform autonomous traveling by estimating a self-position or generating a traveling route using output information of a sensor mounted therein.

As a distance measurement technique of acquiring peripheral circumstances of such a movable apparatus performing autonomous traveling, a distance measurement technique of capturing a parallax image in a case where a subject is viewed from two different viewpoint positions and calculating a depth value of a specific region of the subject based on the parallax image is known.

Also, a technique of using a camera including an optical lens with a wide viewing angle (angle of view), for example, a fisheye lens, to image a subject from two viewpoint positions is known. Moreover, a technique of performing remote monitoring or image recognition using video information acquired by a sensor mounted in a movable apparatus is known.

For example, Japanese Patent Laid-Open No. 2017-102072 discloses a technique of performing imaging in all directions and distance measurement in all directions using a pair of omnidirectional imaging units mounted in a movable apparatus.

However, in the technique of the related art disclosed in Japanese Patent Laid-Open No. 2017-102072, there is a problem that it is difficult to image a blind portion such as a portion below the imaging unit or another imaging unit. For this reason, if imaging of a celestial sphere (horizontal 360°, vertical 180°) and distance measurement in all directions (horizontal 360°) are about to be performed, the number of required imaging units increases.

### SUMMARY OF THE INVENTION

An image processing system of an aspect of the present invention includes
a first imaging unit including a first optical system in which a maximum half angle of view is θa,
a second imaging unit including a second optical system in which a maximum half angle of view is θb,
the first optical system and the second optical system being configured such that the following condition is satisfied, and

θa+θb>180°
an optical axis of the first optical system and an optical axis of the second optical system being disposed in opposite directions to each other,
an image composition unit configured to generate composite image information of a celestial sphere based on outputs of the first imaging unit and the second imaging unit, and
a distance measurement processing unit configured to generate distance information based on an output of a superimposed viewing angle of the first imaging unit and the second imaging unit.

Further features of the present invention will become apparent from the following description of embodiments with reference to the attached drawings.

### BRIEF DESCRIPTION OF THE DRAWINGS

FIG. 1 is a schematic perspective view of an imaging apparatus according to a first embodiment.

FIG. 2 is a functional block diagram illustrating a configuration example of an image processing system 200 according to the first embodiment.

FIGS. 3A and 3B are diagrams illustrating an example of an image acquired by the imaging apparatus according to the first embodiment.

FIG. 4 is a functional block diagram illustrating a configuration diagram of a distance measurement processing unit 204.

FIGS. 5A and 5B are diagrams illustrating an example of a result of executing panoramic processing in image conversion units 402 and 403 according to the first embodiment.

FIGS. 6A and 6B are diagrams illustrating an example of a result of performing trimming in the image processing system according to the first embodiment.

FIG. 7 is a diagram illustrating a principle of stereo distance measurement.

FIG. 8 is a diagram illustrating an example of a result of performing imaging and distance measurement in the image processing system according to the first embodiment.

FIGS. 9A to 9C are diagrams illustrating characteristics of an optical system in a second embodiment.

FIG. 10 is an external perspective view of a movable apparatus according to a third embodiment.

FIG. 11 is a functional block diagram illustrating a configuration example of an autonomous traveling system according to the third embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

Hereinafter, a first embodiment of the present invention will be described.

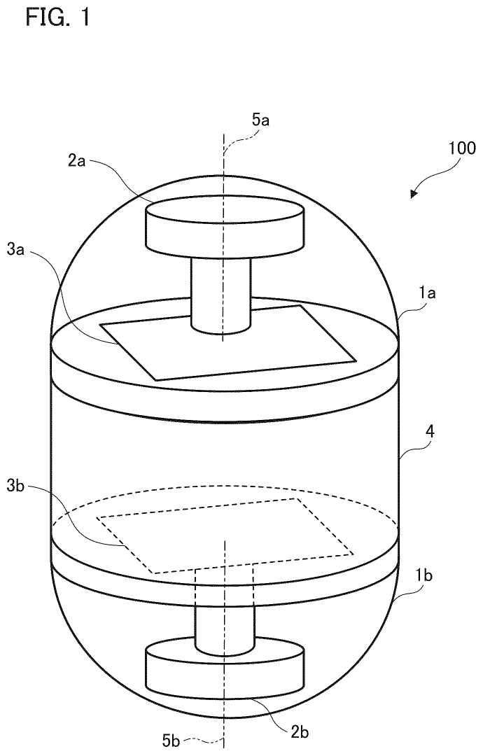

FIG. 1 is a schematic perspective view of an imaging apparatus according to the first embodiment, and an imaging apparatus 100 illustrated in FIG. 1 includes a first imaging unit 1a and a second imaging unit 1b. The first imaging unit 1a and the second imaging unit 1b are provided in such a manner that optical axes 5a and 5b are disposed in a housing 4 on the same axis and in opposite directions to each other.

The first imaging unit 1a includes an imaging element 3a and a first optical system 2a, and the second imaging unit 1b includes an imaging element 3b and a second optical system 2b. The imaging elements 3a and 3b convert light incident via the first optical system 2a and the second optical system 2b into electrical signals, respectively.

For the imaging elements 3a and 3b, a charge coupled device (CCD) image sensor, a complementary metal oxide semiconductor (CMOS) image sensor, or the like is used.

For the first optical system 2a and the second optical system 2b, if a maximum half angle of view of the first optical system 2a is denoted as θa, and a maximum half angle of view of the second optical system 2b is denoted as θb, an optical system satisfying Expression 1 below is used.

$$θ a + θ b > 180 ° \qquad ( 1 )$$

If the optical system satisfying Expression 1 is provided, images to be acquired from the first imaging unit 1a and the second imaging unit 1b have a superimposed angle of view. For example, if θa is 95° and θb is 95°, an angle of view of 85° to 95° of θa and an angle of view of 85° to 95° of θb are a superimposed angle of view.

The first optical system 2a and the second optical system 2b may not have the same angle of view. Moreover, at least one of the first optical system 2a and the second optical system 2b is not limited to an optical system with a fixed angle of view, and may be an optical system with a variable angle of view satisfying Expression 1 above. If the optical system with the variable angle of view is used, a superimposed region of images to be acquired from the first imaging unit 1a and the second imaging unit 1b is variable, and it is possible to change vertical positions of horizontal 360° distance information to be acquired by distance measurement processing that will be described below.

That is, it is possible to optionally change positions in a vertical direction of the distance measurement information, and to efficiently acquire distance information in a range required by the imaging apparatus 100. The first imaging unit 1a and the second imaging unit 1b may be not only the same type of cameras but also a combination of different types of cameras, for example, an infrared camera and a visible light camera.

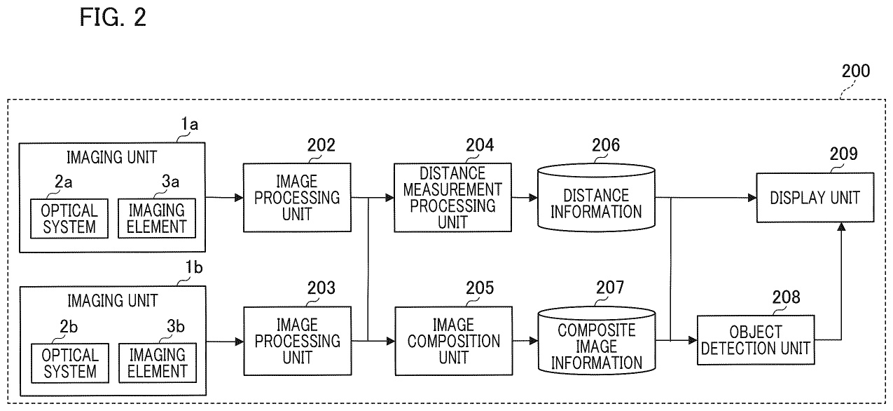

FIG. 2 is a functional block diagram illustrating a configuration example of an image processing system 200 according to the first embodiment. Some of functional blocks illustrated in FIG. 2 are implemented by a CPU or the like serving as a computer (not illustrated) included in the image processing system 200 executing a computer program stored in a memory serving as a storage medium (not illustrated).

Note that some or all of the functional blocks may be implemented by hardware. As hardware, a dedicated circuit (ASIC), a processor (reconfigurable processor or DSP), or the like can be used.

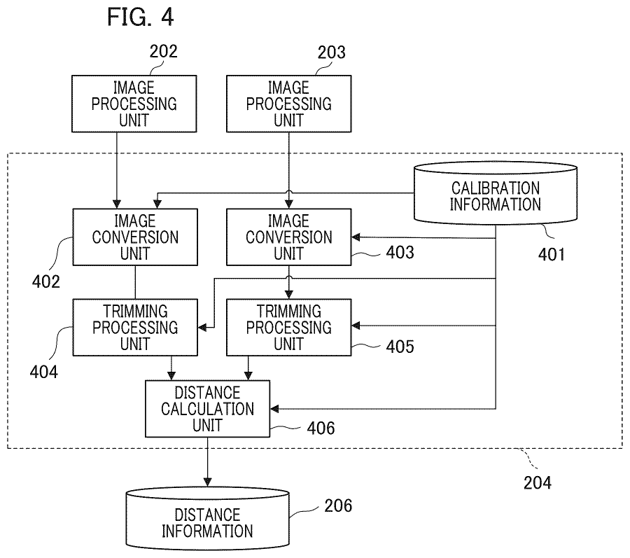

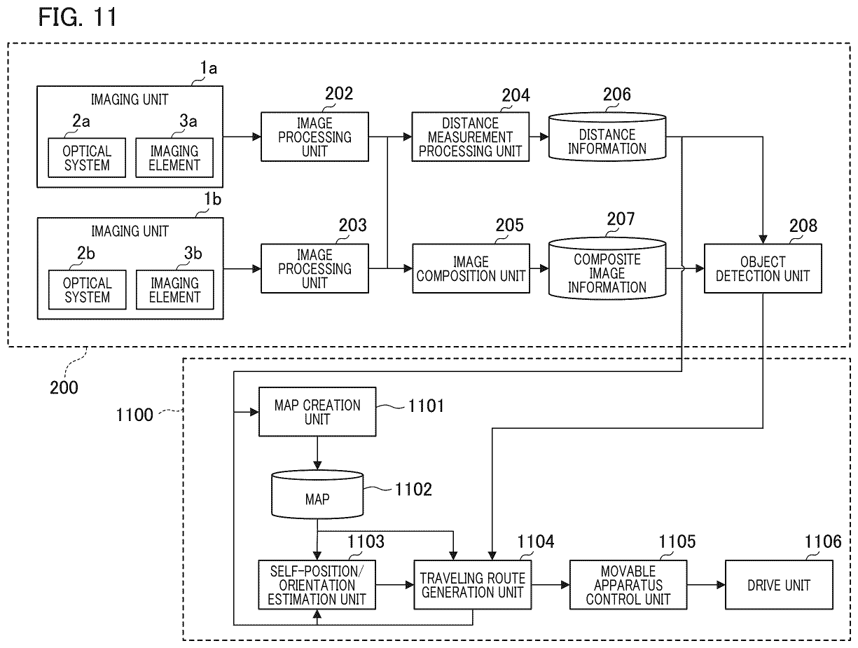

The respective functional blocks illustrated in FIG. 2 may not be built in the same housing, or may be configured with separate devices connected via signal paths. That is, a part of the image processing system 200 may be provided in, for example, an external server. The above description regarding FIG. 2 equally applies to FIGS. 4 and 11.

The image processing system 200 has the first imaging unit 1a and the second imaging unit 1b, image processing units 202 and 203, a distance measurement processing unit 204, an image composition unit 205, an object detection unit 208, and a display unit 209. The image processing units 202 and 203 execute various kinds of image processing such as white balance adjustment, demosaic processing, gain/offset adjustment, gamma correction, and color correction on imaging signals output from the first imaging unit 1a and the second imaging unit 1b, respectively.

The distance measurement processing unit 204 performs distance measurement using a method described that will be below and creates distance information 206 in all directions (horizontal 360°). The image composition unit 205 performs panorama development on each of the imaging signals of the first imaging unit 1a and the second imaging unit 1b, then composes the imaging signals into one image, and creates composite image information 207 of a celestial sphere (horizontal 360°, vertical 180°). That is, the image composition unit 205 generates composite image information of a celestial sphere based on outputs of the first imaging unit 1a and the second imaging unit 1b.

A method of panorama development may be a method based on equirectangular projection or may be a method based on Mercator projection, and the present invention is not limited to these methods. The object detection unit 208 detects an object present in the surroundings of the imaging apparatus 100 by performing image recognition based on the distance information 206 and the composite image information 207. That is, the object detection unit 208 detects an object present in the surroundings based on captured images of the first imaging unit and the second imaging unit and the distance information.

An object to be detected is, for example, a position of an object such as a vehicle, a building, or a person. Only the distance information may be used or only the composite image information may be used for object detection, and the present invention is not limited to the method of object detection.

Moreover, various kinds of information based on a detection result, for example, information indicating various detected objects in a panoramic image and coordinates on the image and information regarding a superimposed image of an object detection result using a bounding box on a panoramic image may be generated and output. The display unit 209 displays the distance information 206, the composite image information 207, object information detected by the object detection unit 208, and the like.

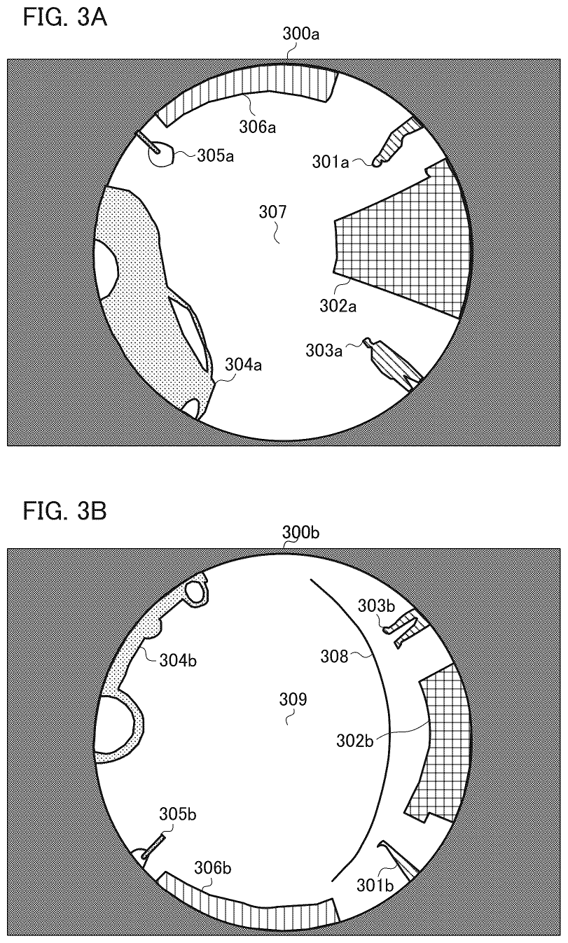

FIGS. 3A and 3B are diagrams illustrating an example of an image acquired by the imaging apparatus according to the first embodiment. In the imaging apparatus as illustrated in FIG. 1, it is assumed that each of the first imaging unit 1a and the second imaging unit 1b includes, for example, an optical system with a wide viewing angle in which a half angle of view is 95°, and the imaging apparatus 100 is provided such that the optical axis 5a is perpendicular to the ground and images the outdoors. In this case, a first image 300a and a second image 300b as illustrated in FIGS. 3A and 3B are acquired by the upper and lower first imaging unit 1a and second imaging unit 1b, respectively.

In the first image 300a, a space 307 is reflected in a central portion, and the vicinity of the ground is reflected in an outer peripheral portion in the surroundings. Moreover, in the second image 300b, the ground 309, a road marking 308, and the like are reflected in a central portion, and the vicinity of the ground is reflected in an outer peripheral portion in the surroundings.

In the first image 300a and the second image 300b, for example, sideways facing pedestrians 301a and 301b, buildings 302a and 302b, front facing pedestrians 303a and 303b, and vehicles 304a and 304b are reflected, respectively. Moreover, in the first image 300a and the second image 300b, trees 305a and 305b and buildings 306a and 306b are reflected, respectively.

The above-described target objects may not be reflected in the first image 300a and the second image 300b depending on an installation position of the imaging apparatus 100 or a peripheral environment. Moreover, the installation position of the imaging apparatus 100 is not limited thereto, and the first image 300a and the second image 300b according to the installation position are acquired.

FIG. 4 is a functional block diagram illustrating a configuration example of a distance measurement processing unit 204. The image conversion units 402 and 403 execute panorama development processing on, for example, celestial sphere images such as the first image 300a and the second image 300b illustrated in FIGS. 3A and 3B output from the image processing units 202 and 203, using calibration information 401 of camera internal/external parameters or the like.

As described above, the method of panorama development may be a method based on equirectangular projection or may be a method based on Mercator projection.

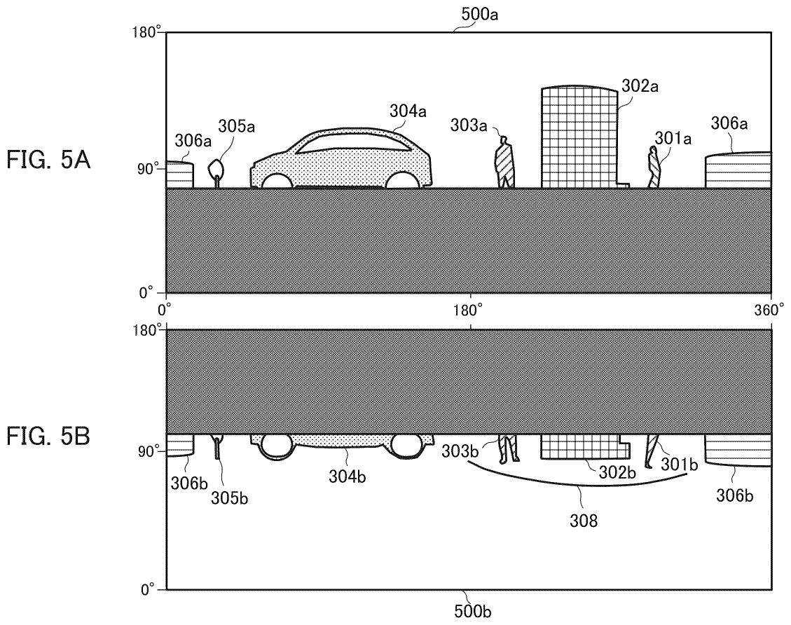

FIGS. 5A and 5B are diagrams illustrating an example of a result of executing panoramic processing in the image conversion units 402 and 403 according to the first embodiment, and are obtained by performing panorama development on the first image 300a and the second image 300b as illustrated in FIGS. 3A and 3B.

A first panoramic image 500a is obtained by performing panorama development on the first image 300a and represents horizontal 360° and vertical 180° composite image information, and a second panoramic image 500b is obtained by performing panorama development on the second image 300b in a similar manner to the first image.

Trimming processing units 404 and 405 of FIG. 4 determine a superimposed angle of view on the panoramic images output from the image conversion units 402 and 403 using the calibration information 401 of camera internal parameters or the like acquired in advance, and cuts a superimposed region from each panoramic image.

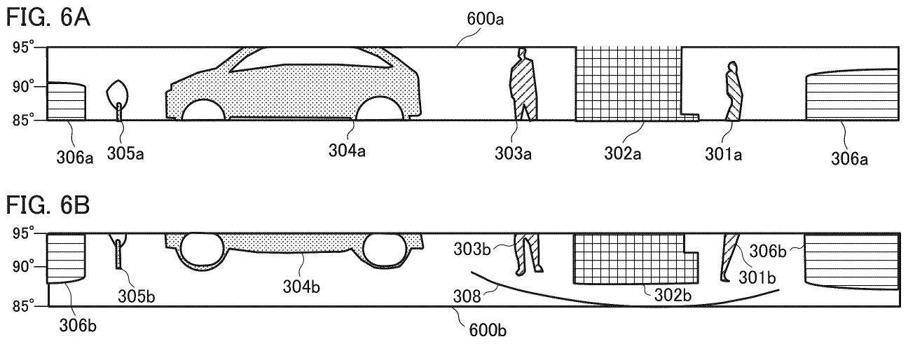

An example of cutting processing of the superimposed region will be described with reference to FIGS. 6A and 6B. FIGS. 6A and 6B are diagrams illustrating an example of a result of performing trimming (cutting) in the image processing system according to the first embodiment. That is, FIGS. 6A and 6B illustrate a result of executing trimming processing of cutting a superimposed region (85° to 95°) of the first panoramic image 500a and the second panoramic image 500b as illustrated in FIGS. 5A and 5B.

A first trimmed image 600a is obtained by trimming a portion of vertical 85° to 95°, which is the superimposed region of the first panoramic image 500a and the second panoramic image 500b, from the first panoramic image 500a. A second trimmed image 600b is obtained by trimming a portion of vertical 85° to 95°, which is the superimposed region of the first panoramic image 500a and the second panoramic image 500b, from the second panoramic image 500b.

As described above, the trimming processing units 404 and 405 cut an image region of a superimposed viewing angle of the first imaging unit and the second imaging unit. The determination of the superimposed region is not limited thereto and may be a method for determining a superimposed region based on the texture of an image, and the present invention is not limited to the determination method.

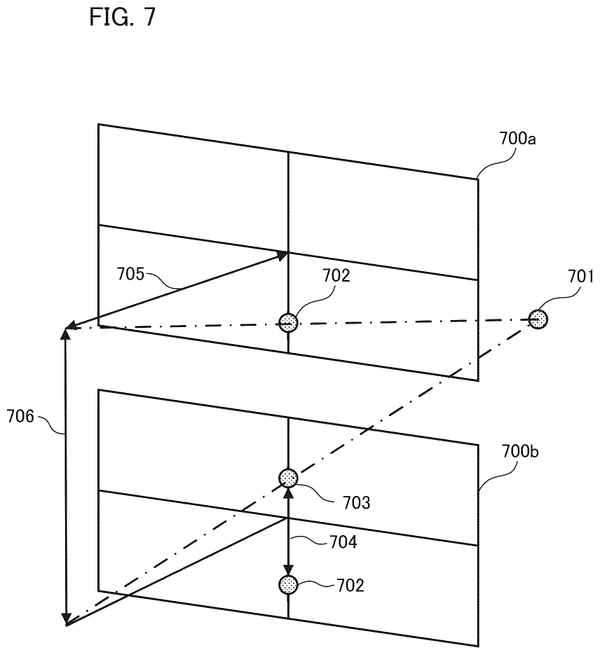

A distance calculation unit 406 of FIG. 4 performs stereo distance measurement based on the trimmed images, which are the outputs of the trimming processing units 404 and 405, and generates distance information. That is, the distance measurement processing unit 204 generates the distance information based on an output of a superimposed viewing angle of the first imaging unit and the second imaging unit. FIG. 7 is a diagram illustrating a principle of stereo distance measurement. Since a measurement target object 701 is different in a viewing way between upper and lower images, the measurement target object 701 is imaged at a position of 702 of an image 700a or at a position of 703 of an image 700b.

Here, the image 700a and the image 700b are images corresponding to the first trimmed image 600a and the second trimmed image 600b output from the trimming processing units 404 and 405. 702 and 703 that are images obtained by imaging the measurement target object into the respective images are, for example, the sideways facing pedestrians 301a and 301b of FIGS. 6A and 6B.

Alternatively, 702 and 703 are the buildings 302a and 302b, the front facing pedestrians 303a and 303b, the vehicles 304a and 304b, the trees 305a and 305b, the buildings 306a and 306b, other animals or structures on a road, or the like.

In this case, parallax 704 that occurs between the image 700a and the image 700b is calculated by performing stereo matching on the image 700a and the image 700b in a longitudinal direction of FIG. 7 and searching for pixel positions with a high degree of similarity of a local feature amount.

The above-described measurement method of parallax is an example, and the present is not limited thereto. Since a focal length 705 and a base length 706 are known values determined depending on installation positions of the optical systems and the imaging units in the housing, if a value of parallax 704 measured on the image is used, it is possible to obtain a distance to the measurement target object 701 from a relationship of similarity between triangles.

Distance information corresponding to the trimmed images is calculated by executing the above-described processing on the trimmed images output from the trimming processing units 404 and 405, for example, the first trimmed image 600a and the second trimmed image 600b of FIGS. 6A and 6B. Moreover, for example, information such as distance images indicating distances to various objects present within a field of view may be generated and output based on the calculated distance information.

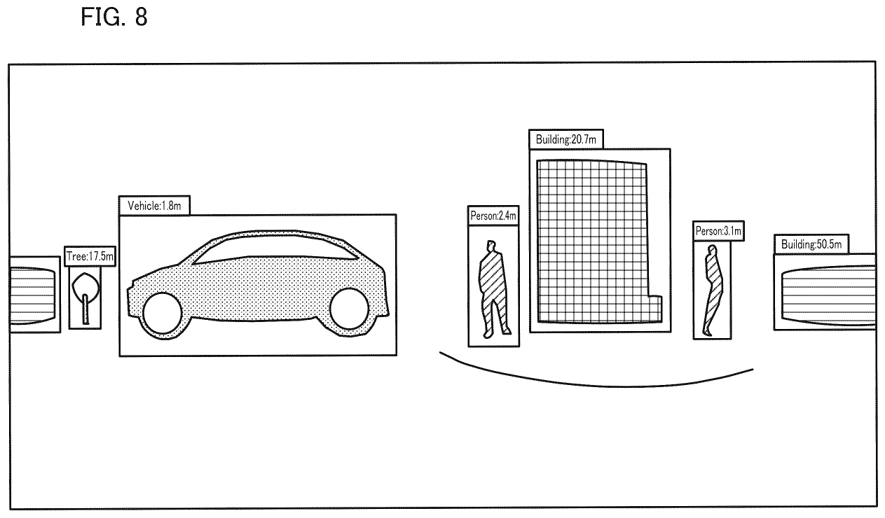

FIG. 8 is a diagram illustrating an example of a result of performing imaging and distance measurement in the image processing system according to the first embodiment, displays the celestial sphere of the imaging apparatus 100 in the form of a panoramic image, and displays object detection results and distance information along with bounding boxes.

A distance displayed in the bounding box is calculated based on the distance image according to the distance information 206 and coordinates of the object in the panoramic image detected by the object detection unit 208 on the image. That is, the distance to the object is calculated by statistical processing of an average value or the like of the distance images in the object. A display method of each of the composite image information, the distance information, and the object detection result is not limited to the example of FIG. 8.

As above, according to the first embodiment, it is possible to acquire the composite image information of the celestial sphere of the imaging apparatus using a small number of imaging units (in this example, two imaging units of the first imaging unit 1a and the second imaging unit 1b) with the celestial sphere (horizontal 360°, vertical 180°) of the imaging apparatus 100 as an imaging target.

Moreover, it is possible to obtain a distance to a specific object present in the surroundings of the imaging apparatus 100 with all directions (horizontal 360°) as a distance measurement target. With this, it is possible to implement the image processing system 200 that acquires the composite image information of the celestial sphere of the imaging apparatus 100 and the distance measurement information in all directions while suppressing an increase in the number of parts and suppressing cost required for manufacturing, installation, and operation, power consumption, and the like.

### Second Embodiment

Hereinafter, a second embodiment of the present invention will be described. In the second embodiment, the distance measurement accuracy of the image processing system 200 is improved by limiting the optical characteristics of the optical system of the first embodiment.

That is, in the second embodiment, the first optical system 2a and the second optical system 2b of the first imaging unit 1a and the second imaging unit 1b are configured as optical systems that generate an image circle having such a characteristic that resolution of a peripheral angle of view is higher than resolution near a center of an optical axis.

Therefore, it is possible to improve the number of pixels of the trimmed images output from the trimming processing units 404 and 405 as illustrated in FIG. 4. Moreover, it is possible to reduce a distance measurement error, variation, or the like, to obtain parallax with excellent accuracy, and perform distance measurement.

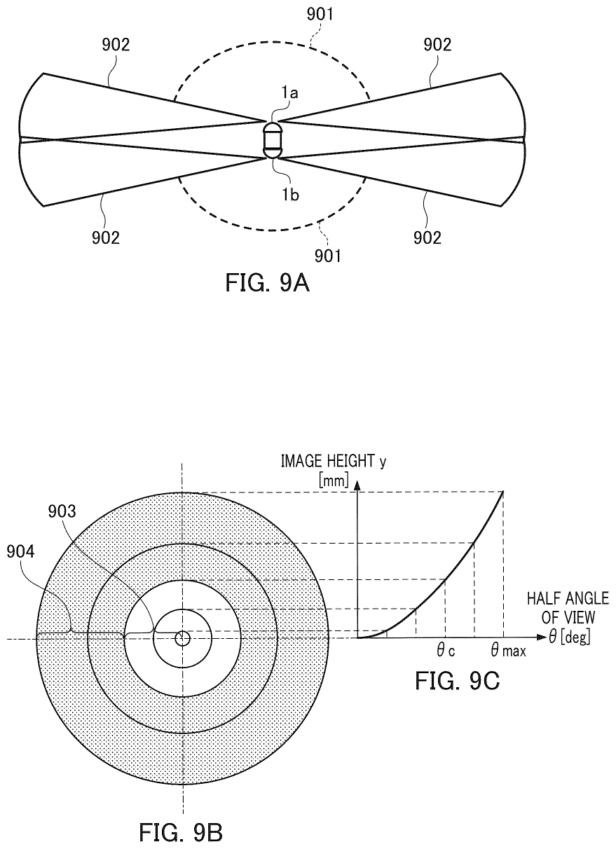

FIGS. 9A to 9C are diagrams illustrating the characteristics of the optical system in the second embodiment. In the second embodiment, the first optical systems 2a and the 2b have the substantially same characteristics, and hereinafter, the characteristics of the first optical system 2a will be exemplarily described.

FIG. 9A is a diagram in a case where the angles of view of the first imaging unit 1a and the second imaging unit 1b provided in the imaging apparatus 100 are viewed from a side surface. As illustrated in FIG. 1, the first imaging unit 1a has the first optical system 2a and the imaging element 3a. The first optical system 2a is different in an image forming magnification between a first angle of view (first field of view) 901 and a second angle of view (second field of view) 902 on a peripheral side with respect to the first angle of view 901.

An imaging surface (light-receiving surface) of the imaging element 3a includes a first region where an object included in the first angle of view 901 is imaged and a second region where an object included in the second angle of view 902 is imaged. Moreover, the number of pixels per unit angle of view in the second region is greater than the number of pixels per unit angle of view in the first region.

In other words, the resolution at the second angle of view (second region) of the first imaging unit 1a is higher than the resolution at the first angle of view (first region). Similarly, for the second imaging unit 1b, the resolution at the second angle of view (second region) is higher than the resolution at the first angle of view (first region).

FIG. 9B is a diagram illustrating, in a contour form, an image height y at each half angle of view on the imaging surface (light-receiving surface) of the imaging element 3a. FIG. 9C is a diagram illustrating a relationship (the projection characteristic of the first optical system 2a) between a half angle of view θ and the image height y in a first quadrant of FIG. 9B.

As illustrated in FIG. 9C, the first optical system 2a is configured such that a projection characteristic y(θ) is different between an angle of view less than a predetermined half angle of view θc and an angle of view equal to or greater than the half angle of view θc. Accordingly, the first optical system 2a has different resolution depending on the angle of view (a region in the light-receiving surface of the imaging element) when an increase amount of the image height y with respect to the half angle of view θ per unit is defined as resolution.

The local resolution can be represented by a derivative dy(θ)/dθ of the projection characteristic y(θ) at the half angle of view θ. For example, it can be said that, as an inclination of the projection characteristic y(θ) of FIG. 9C is greater, the resolution is higher. Moreover, FIG. 9B indicates that, as an interval between the contours of the image height y at each half angle of view is greater, the resolution is higher.

The first optical system 2a of the second embodiment has a projection characteristic that an increase rate (the inclination of the projection characteristic y(θ) of FIG. 9C) of the image height y is small in a central region near the optical axis, and an increase rate of the image height y increases in a peripheral region outside of the central region as the angle of view increases.

In FIG. 9B, a first region 903 including the center corresponds to the angle of view less than the half angle of view θc, and a second region 904 outside the first region corresponds to the angle of view equal to or greater than the half angle of view θc. Moreover, the angle of view less than the half angle of view θc corresponds to the first angle of view 901 in FIG. 9A, and the angle of view equal to or greater than the half angle of view θc corresponds to the second angle of view 902 in FIG. 9A.

Similarly, the angle of view less than the half angle of view θc of the second optical system 2b of the second imaging unit 1b corresponds to the first angle of view 901 in FIG. 9A, and the angle of view equal to or greater than the half angle of view θc corresponds to the second angle of view 902 in FIG. 9A. A superimposed region (for example, a portion of 85° to 95°) of the first panoramic image 500a and the second panoramic image 500b is set such that at least a part thereof has an angle of view equal to or greater than the half angle of view θc. It is desirable that the entire superimposed region has an angle of view equal to or greater than the half angle of view θc.

As described above, the first region 903 is a region with relatively low resolution, and the second region 904 is a region with relatively high resolution. Moreover, the first region 903 is a high distortion region where distortion is relatively large, and the second region 904 is a low distortion region where distortion is relatively small. Accordingly, in the second embodiment, the first region 903 is also referred to as a low resolution region or a high distortion region, and the second region 904 is also referred to as high resolution region or a low distortion region.

The characteristic illustrated in FIGS. 9A to 9C is an example, and the present invention is not limited thereto. For example, the low resolution region and the high resolution region of the optical system may not be configured in a concentric circular shape, or each region may have a distorted shape. Moreover, the center of gravity of the low resolution region may not match the center of gravity of the high resolution region.

Moreover, the center of gravity of the low resolution region and the center of gravity of the high resolution region may deviate from the center of the light-receiving surface of the imaging element. In the optical system of the second embodiment, the low resolution region may be formed near the optical axis, and the high resolution region may be formed on a peripheral side (that is, outside the low resolution region) away from the optical axis.

When a focal length of each of the first optical system 2a and the second optical system 2b is f, a half angle of view is θ, an image height on an image plane is y, a projection characteristic representing a relationship between the image height y and the half angle of view θ is y(θ), and θmax is a maximum half angle of view of the optical system, the optical system is configured such that Expression 2 described below is satisfied. That is, the first optical system 2a is configured such that the projection characteristic y(θ) is different from 2f tan(θ/2) (stereographic projection method).

$$0.2 < 2 \times f \times tan ( θmax / 2 ) / y ( θ max ) < 0.92 \qquad ( 2 )$$

In the optical system having such an optical characteristic, it is possible to adjust a magnification in a radiation direction with respect to the optical axis by adjusting the projection characteristic y(θ).

With this, since it is possible to control an aspect ratio of a ration direction and a circumferential direction with respect to the optical axis, unlike a fisheye lens of the related art, it is possible to obtain a high resolution image with less distortion in a peripheral region while achieving a wide angle of view.

Moreover, it is possible to make the resolution in the second region 904 higher than an optical system using a stereographic projection method by satisfying Expression 2. If the value of 2×f×tan(θmax/2)/y(θmax) exceeds an upper limit of Expression 2, it is not preferable since the resolution in the second region 904 is low and has a small difference from the resolution in the first region 903.

Moreover, if the value of 2×f×tan(θmax/2)/y(θmax) falls below a lower limit of Expression 2, it is not preferable since it is difficult to satisfactorily correct aberrations such as a curvature of field. Expression 2 described above is an example, and the optical system in the second embodiment is not limited thereto.

If the optical system is configured as above, while high resolution is obtained in the peripheral region of the second angle of view 902, in the low resolution region, the increase amount of the image height y with respect to the half angle of view θ per unit is small, and it is possible to image a wide angle of view. That is, it is possible to obtain high resolution in the high resolution region with a wide angle of view equivalent to a fisheye lens as an imaging range.

Moreover, in the second embodiment, the high resolution region has a projection characteristic close to a central projection method (y=f×tan θ) or an equidistant projection method (y=f×θ) which is a projection characteristic of a normal imaging optical system. Accordingly, in the high resolution region, it is possible to generate a fine image with small optical distortion.

It is possible to image the peripheral angle of view of the imaging apparatus 100 with high resolution by disposing the first imaging unit 1a and the second imaging unit 1b having the above-described optical characteristics as described above. Moreover, since the high resolution regions of the first imaging unit 1a and the second imaging unit 1b overlap a superimposed region of the two imaging units, it is possible to acquire distance measurement information with relatively high resolution compared to a fisheye lens of the related art.

### Third Embodiment

In a third embodiment, a form in which the imaging apparatus 100 is mounted on, for example, an autonomous traveling robot, which is a kind of a movable apparatus, will be described.

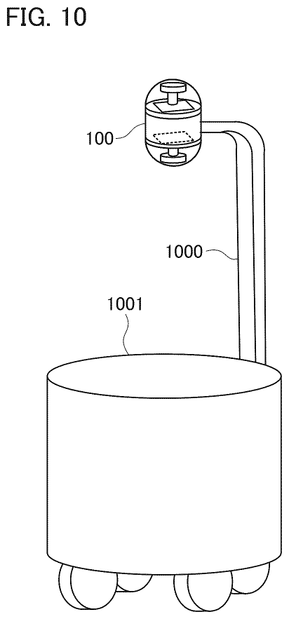

FIG. 10 is an external perspective view of a movable apparatus 1001 according to the third embodiment. The imaging apparatus 100 is provided in an upper portion of the movable apparatus 1001 via a post 1000.

FIG. 11 is a functional block diagram illustrating a configuration example of an autonomous traveling system according to the third embodiment. The autonomous traveling system has an image processing system 200 and an autonomous traveling processing system 1100. The movable apparatus 1001 has the autonomous traveling system and is able to perform autonomous traveling.

In the third embodiment, the movable apparatus has at least a first imaging unit and a second imaging unit mounted thereon. Other portions in the image processing system may be provided in, for example, an external server. The configuration of the image processing system 200 is the same as in the first embodiment, and description will not be repeated.

Next, the autonomous traveling processing system 1100 will be described. A map creation unit 1101 creates a map 1102 required for self-position/orientation estimation and route generation, based on the distance information 206 created by the image processing system 200.

The map 1102 is three-dimensional spatial data such as three-dimensional point cloud data representing features of objects present in a space and structures of floors, walls, and ceilings of buildings or coordinate data of feature points. Moreover, the map 1102 can be updated at any time during traveling of the movable apparatus 1001.

A self-position/orientation estimation unit 1103 estimates a position/orientation of the movable apparatus 1001 based on the distance information 206 and the map 1102 during movement of the movable apparatus 1001.

A traveling route generation unit 1104 generates a traveling route based on the distance information 206, an output of the object detection unit 208, a self-position/orientation estimation result of the self-position/orientation estimation unit 1103, and a detection result of the map 1102. A movable apparatus control unit 1105 controls a movement direction or a speed of the movable apparatus 1001 based on the traveling route generated by the traveling route generation unit 1104. A drive unit 1106 controls wheels and the like of the movable apparatus 1001.

As described above, the movable apparatus 1001 in the third embodiment in which the autonomous traveling system including the imaging apparatus 100 is mounted performs autonomous traveling based on the composite image information of the celestial sphere of the movable apparatus 1001 and the distance information in all directions acquired by the imaging apparatus 100. For this reason, it is possible to implement autonomous traveling of the movable apparatus 1001 while suppressing an increase in the number of parts provided in the movable apparatus 1001 and suppressing costs required for manufacturing, installation, and operation or energy.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing system or the like through a network or various storage media. Then, a computer (or a CPU, an MPU, or the like) of the image processing system or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-144827, filed on Sep. 6, 2023, which is hereby incorporated by reference herein in its entirety.

What is claimed is:

1. An image processing system comprising:
a first imaging unit including a first optical system in which a maximum half angle of view is θa;
a second imaging unit including a second optical system in which a maximum half angle of view is θb,
the first optical system and the second optical system being configured such that the following expression is satisfied, and
$$θ a + θ b > 180 °$$
an optical axis of the first optical system and an optical axis of the second optical system being disposed in opposite directions to each other;
one or more memories storing instructions; and
one or more processors executing the instructions to:
generate composite image information of a celestial sphere based on outputs of the first imaging unit and the second imaging unit, and
generate distance information based on an output of a superimposed viewing angle of the first imaging unit and the second imaging unit.

2. The image processing system according to claim 1,
wherein at least one of the first optical system and the second optical system is an optical system with a variable angle of view.

3. The image processing system according to claim 1,
wherein, when a focal length of each of the first optical system and the second optical system is denoted as f, an image height is denoted as y, and a half angle of view is denoted as θ, a projection characteristic y(θ) satisfies the following condition.
$$0.2 < 2 \times f \times tan ( θmax / 2 ) / y ( θ max ) < 0.92$$

4. The image processing system according to claim 1,
wherein the one or more processors further executes the instructions to
execute trimming processing of cutting an image region of a superimposed viewing angle of the first imaging unit and the second imaging unit, and
generate the distance information based on an output of the trimming processing.

5. The image processing system according to claim 1,
wherein the one or more processors further executes the instructions to detect an object present in surroundings based on captured images of the first imaging unit and the second imaging unit and the distance information.

6. A movable apparatus comprising:
a first imaging unit including a first optical system in which a maximum half angle of view is θa;
a second imaging unit including a second optical system in which a maximum half angle of view is θb,
the first optical system and the second optical system being configured such that the following expression is satisfied, and
θa+θb>180°
an optical axis of the first optical system and an optical axis of the second optical system being disposed in opposite directions to each other;
one or more memories storing instructions; and
one or more processors executing the instructions to:
generate composite image information of a celestial sphere based on outputs of the first imaging unit and the second imaging unit, and
generate distance information based on an output of a superimposed viewing angle of the first imaging unit and the second imaging unit.

7. An image processing method using an imaging apparatus including
a first imaging unit including a first optical system in which a maximum half angle of view is θa, and
a second imaging unit including a second optical system in which a maximum half angle of view is θb,
the first optical system and the second optical system being configured such that the following expression is satisfied, and
θa+θb>180°
an optical axis of the first optical system and an optical axis of the second optical system being disposed in opposite directions to each other, the image processing method comprising:
generating composite image information of a celestial sphere based on outputs of the first imaging unit and the second imaging unit; and
generating distance information based on an output of a superimposed viewing angle of the first imaging unit and the second imaging unit.

8. A non-transitory computer-readable storage medium configured to store a computer program for an imaging apparatus, the imaging apparatus including
a first imaging unit including a first optical system in which a maximum half angle of view is θa, and
a second imaging unit including a second optical system in which a maximum half angle of view is θb,
the first optical system and the second optical system being configured such that the following expression is satisfied, and
$$θ a + θ b > 180 °$$
an optical axis of the first optical system and an optical axis of the second optical system being disposed in opposite directions to each other,
wherein the computer program causes the imaging apparatus to execute the following processes:
generating composite image information of a celestial sphere based on outputs of the first imaging unit and the second imaging unit; and
generating distance information based on an output of a superimposed viewing angle of the first imaging unit and the second imaging unit.
